(19) United States
(12) Patent Application Publication
(10) Pub. No.: US 2014/0372809 A1
(43) Pub. Date: Dec. 18, 2014

(54) GRAPHIC SELF-DIAGNOSTIC SYSTEM AND METHOD

(71) Applicant: GE Medical Systems Global Technology Company LLC, Waukesha, WI (US)

(72) Inventors: Haitao DU, Beijing (CN); Shunyao MA, Beijing (CN)

(21) Appl. No.: 13/916,306

(22) Filed: Jun. 12, 2013

(51) Int. Cl. G06F 11/07

(52) U.S. Cl. CPC G06F 11/079
USPC 714/46

(57) ABSTRACT

A graphic self-diagnostic system comprises an input device for inputting a self-diagnostic request and rendering a request of a user; a graphic self-diagnostic device, comprising a failure database module, a failure scan module and a rendering module, for diagnosing one or more parts of the equipment being diagnosed and for generating the graphic diagnostic result; and an output device for outputting the graphic diagnostic result.

### TECHNICAL FIELD

Embodiments of the present invention relate generally to the field of self-diagnostic technologies, in particular, to a graphic self-diagnostic system and corresponding method.

### BACKGROUND ART

When various pieces of equipment, particularly complex equipment (e.g., X-ray equipment, CT equipment and magnetic resonance equipment) fail, field diagnostics of this equipment usually requires well-trained field engineers on site. If this equipment is deployed in remote rural regions, cost will be very high to send the field engineer.

To solve these problems, equipment can be equipped with self-diagnostic systems, which diagnosis the causes of the equipment's failure. For example, a Vision VDIX140 radiographic machine has a self-diagnostic function; many CT machines or magnetic resonance machines may also include a self-diagnostic function; and even f conventional equipment such as a personal computer (PC) may also have self-diagnostic functions that can self-diagnose whether a CPU, hard disk, memory, fan and the like properly operate or not. These self-diagnostic systems generally provide the equipment parts requiring self-diagnostic with self-diagnostic capability by hardware and/or firmware. The parts requiring self-diagnostic are typically fault-prone and vulnerable; these vulnerable parts are often critical parts.

However, since large-scale equipment often includes complex structures, and a user who uses such equipment often has no specialized knowledge of the relevant equipment construction, even if a self-diagnostic system identifies the cause of the failure and issues an alarm, the user cannot determine the point of failure and troubleshoot accordingly. Corresponding measures, for example, maintaining or even replacing the failed parts, etc., cannot be taken until technicians arrive at the site and examine the equipment. In fact, this does not take full advantage of a self-diagnostic system. When equipment fails, the maintenance cost remains high and it will take a relatively long time to resume the normal operation of the equipment.

### SUMMARY OF THE INVENTION

One of technical problems to be solved by embodiments of the present invention is to provide a simple solution to field failure diagnostic that overcomes or mitigates problems existing in the prior art, and remedies the defects of existing self-diagnostic systems.

According to an embodiment of the present invention, there is provided a graphic self-diagnostic system. The graphic self-diagnostic system comprises an input device configured to at least input at least one of a self-diagnostic request and a rendering request of a user; a graphic self-diagnostic device configured to at least (i) diagnose one or more parts of a piece of equipment, system, machine or device being diagnosed, and (ii) produce a diagnostic result; and an output device configured to at least output the diagnostic result as a graphic diagnostic result. The graphic self-diagnostic device comprises at least a failure database module, a failure scan module and a rendering module.

The failure database module is configured to at least (i) store a whole picture of the piece of equipment, system, machine or device being diagnosed, installation location diagrams and real photos of the one or more parts in advance, and (ii) store information regarding at least one point of failure. The failure scan module is configured to at least scan each of the one or more parts periodically or in response to the self-diagnostic request of the user to at least (i) identify any failed part and store a point of failure for a failed part in the failure database module, and (ii) identify any cleared part whose failure has been cleared and delete a point of failure stored for the cleared part from the failure database module. And the rendering module is configured, in response to the self-diagnostic request of the user, to at least (i) invoke the whole picture from the failure database module and mark the failed part in the whole picture based on the stored point of failure for the failed part, and (ii) invoke at least one of an installation location diagram of the failed part and a real photo of the failed part from the failure database module and provide at least one of the installation location diagram of the failed part and the real photo of the failed part as the graphic diagnostic result to the output device.

In an embodiment of the graphic self-diagnostic system of the present invention, when the installation location diagram or the real photo contains a plurality of parts at the same time, the rendering module adds a marker to the failed part, and then provides the installation location diagram or real photo with the marker to the output device.

In an embodiment of the graphic self-diagnostic system of the present invention, the rendering module generates a red circle, based on coordinates of the failed part in the whole picture, installation location diagram or real photo, at the coordinates, in order to mark the failed part.

In an embodiment of the graphic self-diagnostic system of the present invention, the installation location diagram is a CAD diagram that represents installation locations and/or sizes of one or more parts.

In an embodiment of the graphic self-diagnostic system of the present invention, the parts are circuit components, and the installation location diagram is a circuit wiring diagram that represents installation locations of the circuit components.

In an embodiment of the graphic self-diagnostic system of the present invention, the real photo contains the part number(s) of the part(s).

In an embodiment of the graphic self-diagnostic system of the present invention, the input device and the output device are implemented by the same touch screen.

In an embodiment of the graphic self-diagnostic system of the present invention, the input device is a keyboard and/or a mouse, and the output device is a display and/or a printer.

In an embodiment of the graphic self-diagnostic system of the present invention, the way by which the failure scan module identifies the failed part is one or more of: based on a detecting circuit provided in the part per se; based on a detecting circuit additionally designed for the part; and using an application layer software.

In an embodiment of the graphic self-diagnostic system of the present invention, the graphic self-diagnostic system is arranged in one of radiographic machine, CT equipment, magnetic resonance equipment, household appliance and personal computer.

In an embodiment of the graphic self-diagnostic system of the present invention, the graphic self-diagnostic device can communicate with an upper layer machine and upload the graphic diagnostic result to the upper layer machine.

In an embodiment of the graphic self-diagnostic system of the present invention, the output device can also output the diagnostic result in a form of text message.

In an embodiment of the graphic self-diagnostic system of the present invention, the output device can also output instructions for guiding users to debug or test manually.

In an embodiment of the graphic self-diagnostic system of the present invention, the self-diagnostic request of the user is sent by clicking Diagnostic tag in the touch screen; and the rendering request of the user is sent by clicking the failed part or Forward (“→”) or Backward (“←”) button displayed in the touch screen.

According to an embodiment of the present invention, there is provided a graphic self-diagnostic method. The graphic self-diagnostic method comprises: storing a whole picture of a piece of equipment, system, machine or device being diagnosed, at least one installation location diagram and at least one real photo of one or more parts of the piece of equipment, system, machine or device being diagnosed in advance; and scanning each part of the one or more parts periodically. In response to a self-diagnostic request of a user, the method further comprises at least one of (i) identifying any failed part and storing a point of failure for the failed part, and (ii) identifying any cleared part whose failure has been cleared and deleting the point of failure stored for the cleared part. Further in response to a self-diagnostic request of the user, the method comprises outputting the whole picture and marking the failed part in the whole picture based on the stored point of failure for the failed part. And in response to a rendering request of the user, the method comprises outputting at least one of an installation location diagram of the failed part and a real photo of the failed part.

In an embodiment of the graphic self-diagnostic method of the present invention, when the installation location diagram or the real photo contains a plurality of parts at the same time, a marker is added to the failed part, and then the installation location diagram or real photo with the marker is outputted.

In an embodiment of the graphic self-diagnostic method of the present invention, a red circle is generated, based on coordinates of the failed part in the whole picture, installation location diagram or real photo, at the coordinates, in order to mark the failed part.

In an embodiment of the graphic self-diagnostic method of the present invention, the installation location diagram is a CAD diagram that represents installation locations and/or sizes of one or more parts.

In an embodiment of the graphic self-diagnostic method of the present invention, the parts are circuit components, and the installation location diagram is a circuit wiring diagram that represents installation locations of the circuit components.

In an embodiment of the graphic self-diagnostic method of the present invention, the real photo contains the part number(s) of the part(s).

In an embodiment of the graphic self-diagnostic method of the present invention, a touch screen is used to receive the self-diagnostic request or rendering request of the user, and output the whole picture, the installation location diagram or real photo of the failed part.

In an embodiment of the graphic self-diagnostic method of the present invention, a keyboard and/or a mouse are used to receive the self-diagnostic request or rendering request of the user, and a display and/or a printer are used to output the whole picture, the installation location diagram or real photo of the failed part.

In an embodiment of the graphic self-diagnostic method of the present invention, a way by which the failed part is identified is one or more of: based on a detecting circuit provided in the part per se; based on the detecting circuit additionally designed for the part; and using an application layer software.

In an embodiment of the graphic self-diagnostic method of the present invention, the graphic self-diagnostic method is performed in one of radiographic machine, CT equipment, magnetic resonance equipment, household appliance and personal computer.

In an embodiment of the graphic self-diagnostic method of the present invention, the graphic diagnostic result is uploaded to an upper layer machine by communicating with the upper layer machine.

In an embodiment of the graphic self-diagnostic method of the present invention, the diagnostic result is also outputted in a form of text message.

In an embodiment of the graphic self-diagnostic method of the present invention, instructions for guiding users to debug or test manually are also outputted.

In an embodiment of the graphic self-diagnostic method of the present invention, the self-diagnostic request of the user is sent by clicking Diagnostic tag in the touch screen; and the rendering request of the user is sent by clicking the failed part or Forward (“→”) or Backward (“←”) button displayed in the touch screen.

According to an embodiment of the present invention, there is provided a radiographic machine. The radiographic machine comprises the graphic self-diagnostic system of any of the embodiments described above.

According to an embodiment of the present invention, a user can easily identify the specific failed part and accordingly handle the repair with the use of the graphic self-diagnostic system, thereby reducing related maintenance cost and reducing shut-down time.

According to an embodiment of the present invention, in many instances, engineers can know the failure without need for arriving at the site, and hence determine whether he should go in person or whether he should carry some new parts to the site to replace the failed parts, thus reducing the number of round trips and time for engineers, and saving the cost.

According to an embodiment of the present invention, a piece of equipment, machine, system or device can take full advantage of the self-diagnostic system described herein, such that both users and the equipment, machine system or device vendors can rely more readily on the self-diagnostic system.

### BRIEF DESCRIPTION OF THE DRAWINGS

Other objects, advantages and novel features of the invention will become apparent from the following detailed description of the invention when considered in conjunction with the accompanying drawings, in which:

FIG. 1 schematically illustrates an exemplary radiographic machine system in which embodiments of the present invention may be applied;

FIG. 2 schematically illustrates a simplified structural diagram of a U arm control screen of the radiographic machine according to an embodiment of the present invention;

FIG. 3 schematically illustrates a simplified structural diagram of the graphic self-diagnostic system according to an embodiment of the present invention;

FIG. 4 is a flowchart illustrating various steps in a self-diagnostic flow performed by the failure scan module in the graphic self-diagnostic device according to an embodiment of the present invention;

FIG. 5 is a flowchart illustrating various steps in a self-diagnostic flow performed by the rendering module in the graphic self-diagnostic device according to an embodiment of the present invention;

FIG. 6 illustrates a schematic diagram of the self-diagnostic graphic rendering according to an embodiment of the present invention; and

FIGS. 7, 8, and 9 respectively illustrate a main page, CAD page and a photo page for a graphic self-diagnostic according to embodiments of the present invention.

### DETAILED DESCRIPTION

In the following, the present invention will be described in more detail with reference to illustrative embodiments and to accompanying drawings. For purposes of explanation and not limitation, specific details are set forth, such as particular systems, structures and techniques, etc., in order to enable those skilled in the art to readily understand the present invention. However, it will be apparent to those skilled in the art that the present invention may be practiced in other embodiments without these specific details described herein.

Those skilled in the art will readily appreciate that all or some of various parts of the system and/or various steps of the method described herein may be implemented in hardware, software and/or firmware. The present invention is not limited to any specific combination of hardware and software.

Furthermore, while the present invention is primarily described in the form of systems and methods, the present invention may also be embodied in a computer program product as well as in a non-transitory readable medium having stored thereon instructions executable by a computer or processor to perform any or all of the functions of the systems and methods described herein, or a computer system comprising a processor and a memory coupled to the processor, wherein the memory may store one or more program codes that may perform the functions disclosed herein.

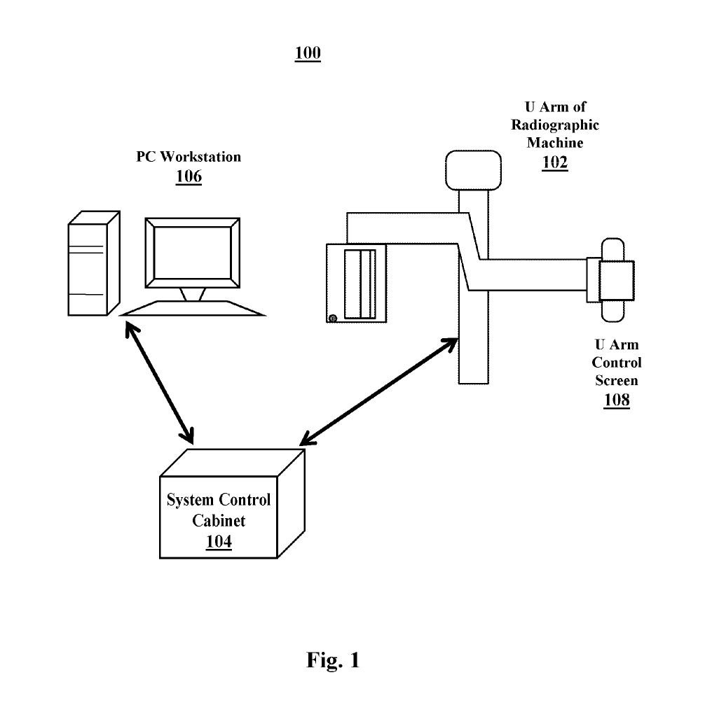

FIG. 1 schematically illustrates an exemplary radiographic machine system 100 in which the present invention may be implemented. While the embodiments of present invention are described mainly with reference to a radiographic machine, it should be noted that this description is in no way intended to limit the scope of application of the present invention, and the present invention may also be applied to other complex equipment, machine, system, device, etc., in whole or in part, such as CT equipment, magnetic resonance equipment, etc., or relatively simple conventional equipment such as household appliances or a personal computer (PC), etc., and the like.

As shown in FIG. 1, the radiographic machine system 100 mainly comprises a radiographic machine (only a U arm 102 and a U arm control screen 108 of the radiographic machine are shown in the figure), a system control cabinet 104 and a PC workstation 106. An X-ray tube and an X-ray detector (not shown) are installed on the U arm 102 of the radiographic machine, for radiography. The U arm 102 can move up and down, rotate and extend and retract, and be responsible for positioning the patient. The system control cabinet 104 supplies power to the radiographic machine, and produces high voltage required for the X-ray tube. The PC workstation 106 can be used for test setting and image processing. The U arm control screen 108 may be installed on the U arm 102 of the radiographic machine, and is responsible for adjusting exposure parameters, reporting various position information and configuring and calibrating the U arm 102.

In an embodiment of the present invention, a graphic self-diagnostic device is arranged on the U arm control screen 108, as will be described in details hereinafter.

In an embodiment of the present invention, a graphic self-diagnostic device is arranged in the PC workstation 106. As to a piece of equipment without a part (such as the U arm control screen 108) being capable of inputting/outputting information, the graphic self-diagnostic device may be added with the aid of the PC workstation connected to the piece of equipment. The location of the graphic self-diagnostic device is not limited to the position described herein. Instead, said location may depend on specific equipment and design requirements.

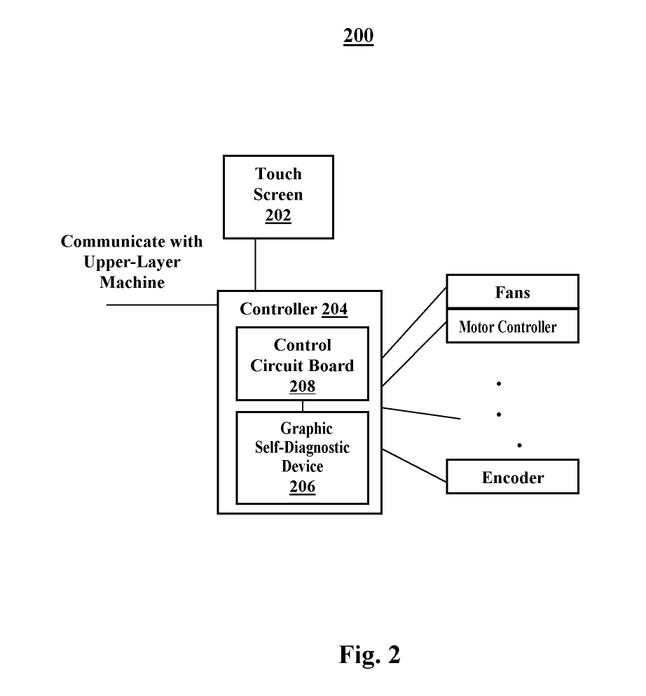

FIG. 2 schematically illustrates a structural diagram 200 of the U arm control screen according to an embodiment of the present invention. In the illustrated embodiment, the U arm control screen 108 comprises a touch screen 202 and a controller 204 being communicatively connected with each other. The touch screen 202 is only one example of an input/output (I/O) device, which can be replaced with a keyboard and/or a mouse and a display and/or a printer. The controller 204 may be comprised of specially designed discrete components and/or an application specific integrated circuit, or of a general purpose microprocessor or digital signal processor and memory. In an embodiment of the present invention, the controller 204 comprises a control circuit board 208 for controlling one or more parts of the equipment being diagnosed, and a graphic self-diagnostic device 206, which may be implemented in software and/or hardware and/or firmware for self-diagnostic.

In an embodiment of the present invention, the graphic self-diagnostic device 206 is separately arranged outside of the controller 204, and connected to the input/output device such as touch screen.

In an embodiment of the present invention, the graphic self-diagnostic device 206 can also communicate with an upper layer machine and upload the graphic diagnostic result to the upper layer machine.

In an embodiment of the present invention, the U arm control screen 108, being equipped with the graphic self-diagnostic device 206, can diagnose an abnormity of any or all electrical parts and critical parts on the U arm 102 of the radiographic machine, and provide the self-diagnostic result in a graphic manner, described later. The parts that can be diagnosed comprise, for example, without limitation, fans, motor controllers, potentiometer(S), grid position(s), electromagnetic brake(s), travel switch(es), button(s), encoder(s), etc.

Depending on specific parts and specific designs, the graphic self-diagnostic device 206 can gather diagnostic information in various ways. As an example, the graphic self-diagnostic device 206 may gather fan state information by the detecting circuit or sensor provided in a fan per se, and thus diagnose the proper operation or improper operation of the fan; with regard to the electromagnetic brake, a voltage dividing circuit may be specially designed to detect its operating parameters, and thus diagnose the proper operation or improper operation of the electromagnetic brake; with regard to the motor controller, its heart beat message is tested by using an application layer software to determine whether the motor controller operates properly or improperly.

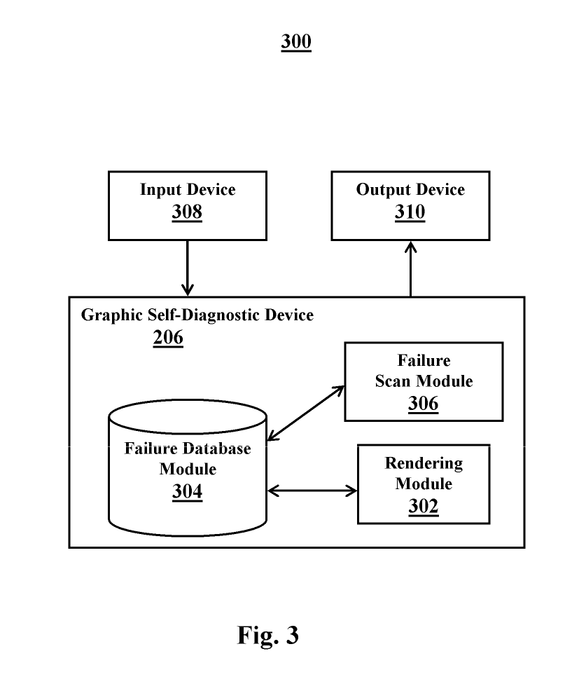

FIG. 3 schematically illustrates a simplified structural diagram 300 of the graphic self-diagnostic system according to an embodiment of the present invention.

As shown in the figure, according to an embodiment, the graphic self-diagnostic system 300 comprises an input device 308 for inputting a self-diagnostic request and rendering request of a user, a graphic self-diagnostic device 206 for diagnosing one or more parts of an equipment being diagnosed and for generating the graphic diagnostic result, and an output device 310 for outputting the graphic diagnostic result.

The graphic self-diagnostic device 206 comprises at least a failure database module 304, a failure scan module 306 and a rendering module 302. The failure database module 304 is configured to store a whole picture of the equipment being diagnosed, the installation location diagrams and real photos of the one or more parts in advance, and for storing information regarding point(s) of failure. The failure scan module 306 is configured to scan each part periodically or in response to the self-diagnostic request of the user, thus to identify the failed part and store it as a point of failure in the failure database module, or identify the part whose failure has been cleared and accordingly delete the point of failure stored for the part. And the rendering module 302, in response to the self-diagnostic request of the user, is configured to invoke the whole picture from the failure database module and mark the failed part in the whole picture based on the stored information regarding the point of failure; and also in response to the rendering request of the user, is configured to invoke from the failure database module the installation location diagram of the failed part and/or the real photo of the failed part, and providing them as the graphic diagnostic result to the output device.

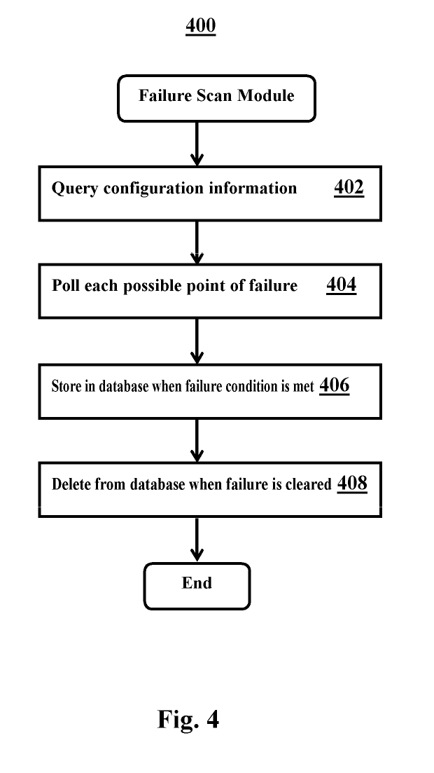

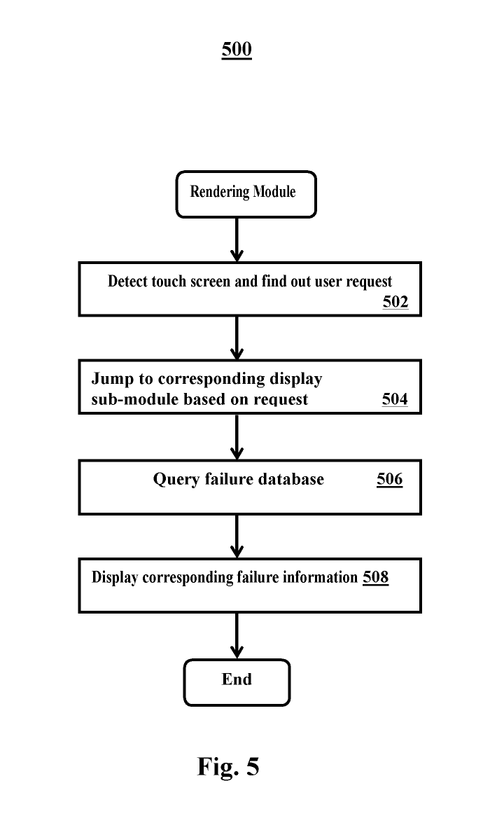

The workflows of the rendering module 302 and the failure scan module 306 will later be explained in detail with reference to FIGS. 4 and 5.

In an embodiment of the present invention, in addition to storing the point of failure data, the failure database module 304 stores the following graphs in advance: the whole picture of the equipment being diagnosed; CAD page 1-n (n≧1), each displaying the installation locations and/or sizes of one or more parts; and photo page 1-n (n≧1), each displaying the real photo of one or more parts and related part number(s).

The number of parts included on one CAD page or on one photo page may be determined based on the size of the storage space and the relationship between the parts.

In an embodiment of the present invention, since the critical portion being diagnosed is a circuit board, a CAD page may be replaced with a circuit wiring diagram (e.g., a PCB diagram generated by Protel®) that represents positional relationship between circuit components. Whichever drawing tool is used, any of pictures that can display the installation location and sizes of the parts of interest may be used, other than a CAD page.

These pre-stored graphs may be invoked by the rendering module 302 and displayed on the U arm control screen 108.

FIG. 4 is a flowchart illustrating the steps in a self-diagnostic flow performed by the failure scan module in the graphic self-diagnostic device according to an embodiment of the present invention. In Step 402, the failure scan module 306 queries the U arm configuration information (the configuration information may be the list of parts of the equipment stored in the database in advance); this step is optional, and the step may not be performed when the configuration information remains unchanged. In Step 404, the failure scan module 306 automatically polls each possible point of failure periodically, or polls each possible point of failure in response to the self-diagnostic request of the user (for example, the user clicks a “Diagnostic” tag on screen), the possible points of failure include for example fans, motor controller(s), potentiometer(s), grid position(s), electromagnetic brake(s), travel switch(es), button(s), encoder(s) and the like. In Step 406, if the diagnostic information gathered from a polled part (e.g., a fan) meets a failure condition (e.g., the measured temperature is above a first threshold and/or the measured rotation speed is below a second threshold), the part (i.e. its name or other identifier) is stored in the failure database as a point of failure. In Step 408, when the failure of the part is removed, the part is deleted from the failure database. Step 406 and Step 408 may actually be performed synchronously, i.e., the failed part and the part that was failed but has been recovered may be identified completely through one pass of polling.

FIG. 5 is a flowchart illustrating the steps in a self-diagnostic flow performed by the rendering module in the graphic self-diagnostic device according to an embodiment of the present invention. In Step 502, the rendering module 302 detects the touch screen 202 to find the self-diagnostic request (for example, the user clicks a “Diagnostic” tag on the screen) or rendering request (for example, the user clicks a failed part in the whole picture displayed in the graphic area, or presses Forward/“→” or Backward/“←” button on lower right of the screen) from the user. In Step 504, the rendering module 302 jumps to corresponding graphic display sub-module based on the request inputted by the user, for example, in response to the self-diagnostic request of the user, invokes the whole picture from the failure database module; or in response to the rendering request of the user, invokes the installation location diagram and/or real photo of the failed part from the failure database module, thereby switching the whole picture to the CAD page of the failed part, or further switching the CAD page to the photo page of the failed part. In Step 506, the rendering module 302 queries the failure database 304 for the stored point(s) of failure. In Step 508, the rendering module 302 displays corresponding failure information on the touch screen 202, for example, marks one or more points of failure in the displayed whole picture, based on the stored point(s) of failure. It should be pointed out that the invoking in Step 504 and the querying in Step 506 and the marking in Step 508 can be performed synchronously.

In an embodiment of the present invention, when an installation location diagram or real photo pre-stored in the failure database contains a plurality parts at the same time, the rendering module can add a marker only to the failed part, and then output the installation location diagram or real photo with the marker to the output device for rendering.

In an embodiment of the present invention, the rendering module generates a visible marking, such as a visible circle or, more particularly, a visible red circle, based on coordinates of the failed part in the whole picture, installation location diagram or real photo, at the coordinates, in order to mark the failed part.

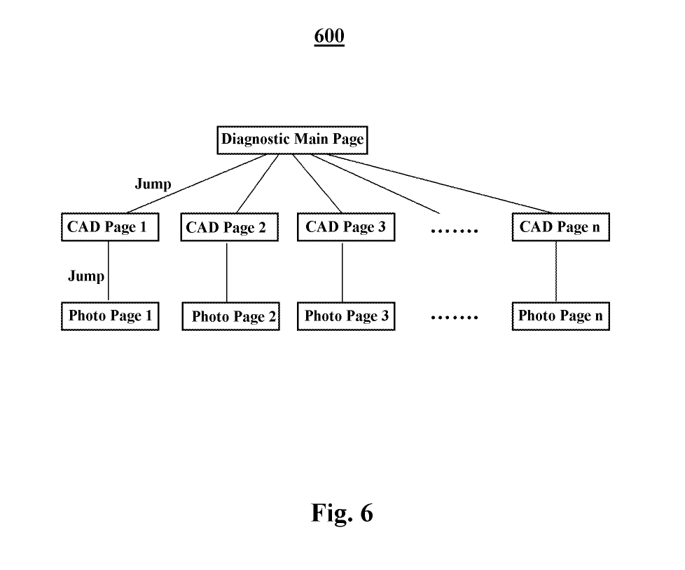

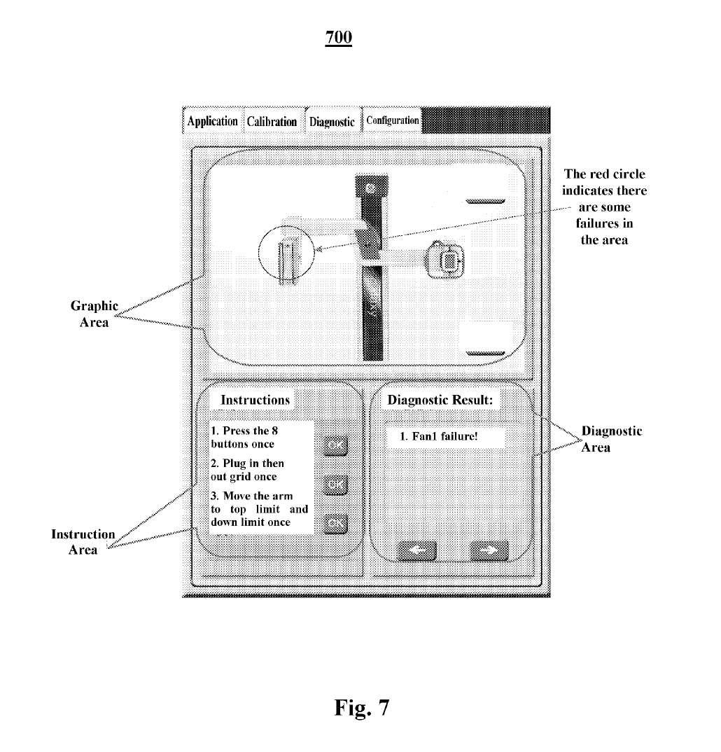

How a user uses the graphic self-diagnostic will be described in details below in conjunction with FIGS. 6-9. FIG. 6 illustrates a schematic diagram of the self-diagnostic graphic rendering according to an embodiment of the present invention. FIGS. 7-9 respectively illustrate a main page, a CAD page and a photo page for graphic self-diagnostic according to an embodiment of the present invention.

In an embodiment of the present invention, initially, when the user clicks a “Diagnostic” tab on the touch screen 202 of the U arm control screen 108, the whole picture of the equipment being diagnosed would be displayed on the touch screen 202 as the diagnostic main page. When the user clicks an area on the diagnostic main page, the diagnostic main page will be switched to the CAD page of the part in the clicked area, where the installation location and/or size of the part would be displayed on the CAD page. At the same time, two buttons are also displayed on lower right of the screen, pressing one of them may return to the main page, and pressing the other may proceed to a related photo page, in which the real photo of the part and its unique part number are displayed.

In an embodiment of the present invention, when the user clicks the “Diagnostic” tab, the failure scan module is activated to perform the above-mentioned steps 402-408. If the failure scan module identifies one or more failed parts, it stores these parts as points of failure in the failure database.

At the same time, the rendering module would query the failure database and display corresponding failure information, for example, dynamically add one or more markers (e.g., red circles) at one or more parts on the displayed diagnostic main page, to indicate that these parts are failed or malfunctioning parts, and thus prompt the user to click/press a related area, so as to further view the installation location and/or size of the failed part via the CAD page, and view appearance and/or part number of the failed part via the photo page.

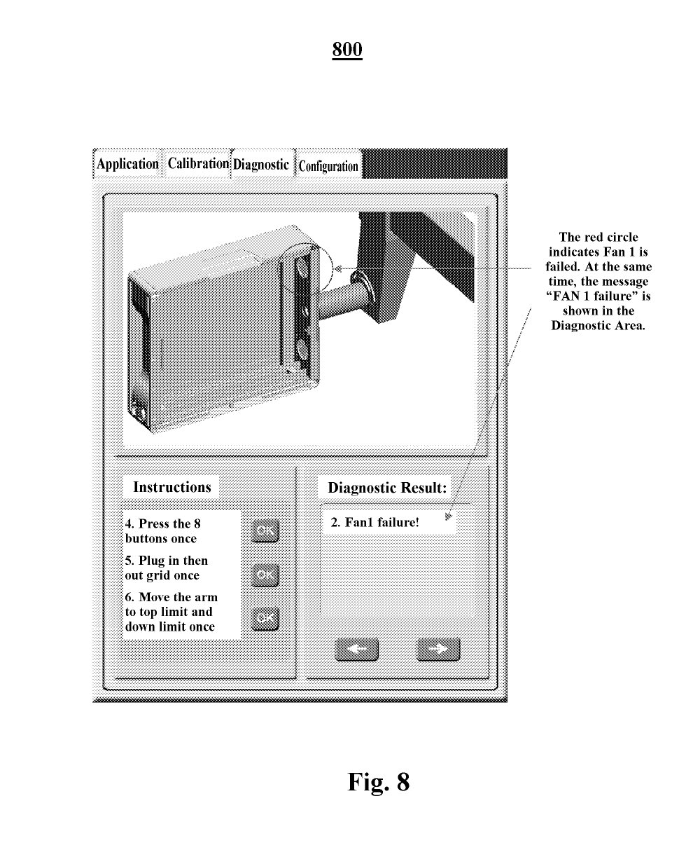

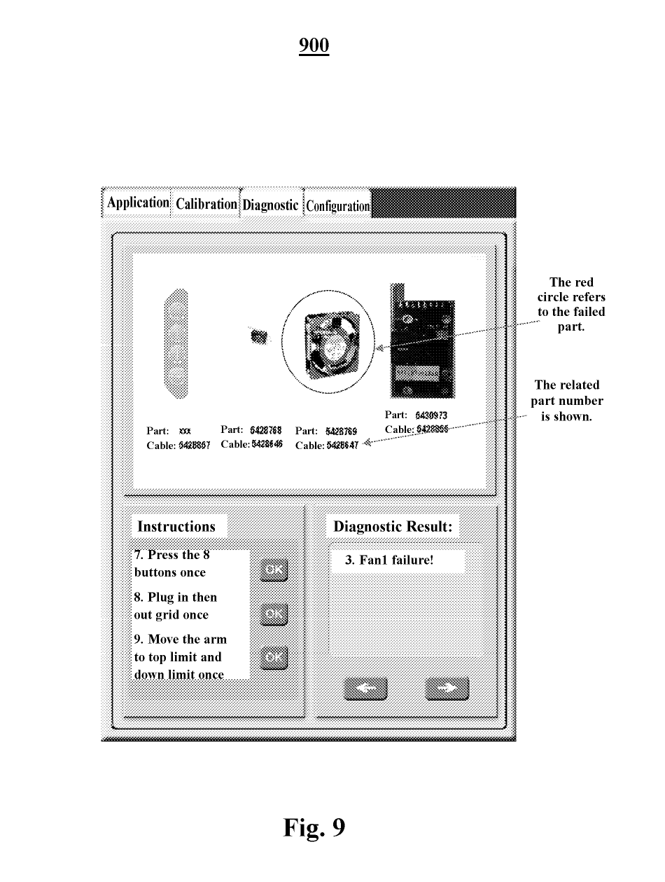

For example, FIG. 7 illustrates the diagnostic main page of the U arm positioner. When the page is entered, the marked red circle indicates that there is some failure in the housing area. The user clicks the red circle area, such that the CAD page about the housing area is displayed on screen, as shown in FIG. 8, in which the red circle indicates that the fan 1 is failed (i.e. is a failed or malfunctioning part), while a message, such as, “Fan1 failure!” is displayed in the diagnostic area. When the user clicks the red circle in the CAD page, a photo page is displayed on the screen, as shown in FIG. 9. In the photo page, the real photo of the failed part (e.g., fan 1) is displayed, and the part number of the part may be displayed simultaneously. If the photo page includes more than one part, the failed part is marked with a red circle.

In an embodiment of the present invention, an Instruction Area is also displayed on or toward the lower left of various pages, in which some of the operation steps are displayed to guide the user to debug or test a part or parts manually. For some parts whose failures cannot finally be determined solely by the self-diagnostic function, these manual tests are useful to diagnose or pinpoint a failed or malfunctioning part. A user of the equipment can easily identify the specific failed part and accordingly address it with the use of the graphic self-diagnostic system and method, thereby reducing related maintenance cost and reducing shut-down time.

Compared to the prior art, the graphic self-diagnostic system and method according to the embodiments of the present invention may bring about many benefits. For example, with the aid of the installation location and/or size of the part in the CAD page and the real photo and its part number in the photo page, the user can determine the position of the failed part in the equipment and appearance of the failed part easily, thus determine or pinpoint the failed part by himself, and remove the part if necessary. As another example, the user can better cooperate with remote technicians for troubleshooting; for example, the user may determine or pinpoint the failed part and inform technicians of various specification data (e.g., rated power, etc.) shown thereon, so that technicians can carry the correct replacement parts to the site for replacing all or most of the failed parts, thus avoiding extra service visits, which in turn, minimizes equipment downtime and maintenance/service costs.

The above mentioned and described embodiments are only given as examples and should not be construed to limit the present invention. Although specific terms may be employed herein, they are used in a generic and descriptive sense only and not for purposes of limitation. It is intended that the scope of the invention be defined only by the claims appended hereto and their equivalents.

1. A graphic self-diagnostic system, comprising:
an input device configured to at least input at least one of a self-diagnostic request and a rendering request of a user;
a graphic self-diagnostic device configured to at least (i) diagnose one or more parts of a piece of equipment, system, machine or device being diagnosed, and (ii) produce a diagnostic result; and
an output device configured to at least output the diagnostic result as a graphic diagnostic result,
wherein the graphic self-diagnostic device comprises:
a failure database module configured to at least (i) store a whole picture of the piece of equipment, system, machine or device being diagnosed, at least one installation location diagram and at least one real photo of the one or more parts in advance, and (ii) store information regarding at least one point of failure;
a failure scan module configured to at least scan each of the one or more parts periodically or in response to the self-diagnostic request of the user to at least (i) identify any failed part and store a point of failure for a failed part in the failure database module, and (ii) identify any cleared part whose failure has been cleared and delete a point of failure stored for a cleared part from the failure database module; and
a rendering module configured, in response to the self-diagnostic request of the user, to at least (i) invoke the whole picture from the failure database module and mark the failed part in the whole picture based on the stored point of failure for the failed part, and (ii) invoke at least one of an installation location diagram of the failed part and a real photo of the failed part from the failure database module and provide at least one of the installation location diagram of the failed part and the real photo of the failed part as the graphic diagnostic result to the output device.

2. The graphic self-diagnostic system according to claim 1, wherein, when the installation location diagram of the failed part or the real photo of the failed part contains more than one of the one or more parts at the same time, the rendering module is further configured to add a marker to the failed part and provide the installation location diagram or the real photo with the marker to the output device.

3. The graphic self-diagnostic system according to claim 2, wherein the rendering module is further configured to generate a visible circle, based on coordinates of the failed part in the whole picture, the installation location diagram or the real photo, at the coordinates, in order to mark the failed part.

4. The graphic self-diagnostic system according to claim 1, wherein the installation location diagram is a CAD diagram representing at least one of installation locations and sizes of the one or more parts.

5. The graphic self-diagnostic system according to claim 1, wherein the one or more parts are circuit components, and one of the installation location diagrams is a circuit wiring diagram that represents installation locations of the circuit components.

6. The graphic self-diagnostic system according to claim 1, wherein the real photo comprises at least one part number of the one or more parts.

7. The graphic self-diagnostic system according to claim 1, wherein the input device and the output device are implemented by a touch screen.

8. The graphic self-diagnostic system according to claim 1, wherein the input device is at least one of a keyboard and a mouse, and the output device is at least one of a display and a printer.

9. The graphic self-diagnostic system according to claim 1, wherein the failure scan module identifies the failed part by using one or more of:
a detecting circuit provided in one of the one or more parts;
a detecting circuit additionally designed for one of the one or more parts; and
an application layer software.

10. The graphic self-diagnostic system according to claim 1, wherein the graphic self-diagnostic system is configured to maintain a radiographic system, machine or device, a CT system, machine or device, a magnetic resonance system, machine or device, a household appliance or a personal computer.

11. The graphic self-diagnostic system according to claim 1, wherein the graphic self-diagnostic device is further configured to communicate with an upper layer machine and to upload the graphic diagnostic result to the upper layer machine.

12. The graphic self-diagnostic system according to claim 1, wherein the output device is further configured to output the diagnostic result in a form of a text message.

13. The graphic self-diagnostic system according to claim 1, wherein the output device is further configured to output instructions to guide the user to debug or test at least one of the one or more parts manually.

14. The graphic self-diagnostic system according to claim 7, wherein the self-diagnostic request of the user is sent by clicking a Diagnostic tag in the touch screen, and the rendering request of the user is sent by clicking a button representing the failed part, a Forward button, or a Backward button displayed in the touch screen.

15. A graphic self-diagnostic method, comprising:
storing a whole picture of a piece of equipment, system, machine or device being diagnosed, at least one installation location diagram and at least one real photo of one or more parts of the piece of equipment, system, machine or device being diagnosed in advance;
scanning each part of the one or more parts periodically;
in response to a self-diagnostic request of a user, at least one of (i) identifying any failed part and storing a point of failure for a failed part, and (ii) identifying any cleared part whose failure has been cleared and deleting the point of failure stored for a cleared part;
in response to the self-diagnostic request of the user, outputting the whole picture and marking the failed part in the whole picture based on the stored point of failure for the failed part; and
in response to a rendering request of the user, outputting at least one of an installation location diagram of the failed part and a real photo of the failed part.

16. The graphic self-diagnostic method according to claim 15, wherein, when the installation location diagram of the failed part or the real photo of the failed part contains more than one of the one or more parts at the same time, the method further comprises:
adding a marker to the failed part; and
outputting the installation location diagram or the real photo with the marker.

17. The graphic self-diagnostic method according to claim 16, further comprising generating a visible circle, based on coordinates of the failed part in the whole picture, the installation location diagram of the failed part, or the real photo of the failed part, at the coordinates, to mark the failed part.

18. The graphic self-diagnostic method according to claim 15, wherein the installation location diagram is a CAD diagram representing at least one of installation locations and sizes of the one or more parts.

19. The graphic self-diagnostic method according to claim 15, wherein the one or more parts are circuit components, and one of the installation location diagrams is a circuit wiring diagram that represents installation locations of the circuit components.

20. The graphic self-diagnostic method according to claim 15, wherein the real photo comprises at least one part number of the one or more parts.

21. The graphic self-diagnostic method according to claim 15, further comprising using a touch screen to receive the self-diagnostic request or the rendering request of the user, and to output the whole picture, the installation location diagram of the failed part, or the real photo of the failed part.

22. The graphic self-diagnostic method according to claim 15, further comprising:
using at least one of a keyboard and a mouse to receive the self-diagnostic request or the rendering request of the user; and
using at least one of a display and a printer to output the whole picture, the installation location diagram of the failed part, or the real photo of the failed part.

23. The graphic self-diagnostic method according to claim 15, wherein the failed part is identified by using one or more of:
a detecting circuit provided in one of the one or more parts;
a detecting circuit additionally designed for one of the one or more parts; and
using an application layer software.

24. (canceled)

25. The graphic self-diagnostic method according to claim 15, further comprising uploading a graphic diagnostic result to an upper layer machine by communicating with the upper layer machine.

26. The graphic self-diagnostic method according to claim 15, further comprising outputting a diagnostic result in a form of a text message.

27. The graphic self-diagnostic method according to claim 15, further comprising outputting instructions for guiding the user to debug or test at least one of the one or more parts manually.

28. The graphic self-diagnostic method according to claim 21, wherein the self-diagnostic request of the user is sent by clicking a Diagnostic tag in the touch screen, and the rendering request of the user is sent by clicking a button representing the failed part, a Forward button, or a Backward button displayed in the touch screen.

29. A radiographic machine, comprising:
an input device configured to at least input at least one of a self-diagnostic request and a rendering request of a user;
a graphic self-diagnostic device configured to at least (i) diagnose one or more parts of a piece of equipment, system, machine or device being diagnosed, and (ii) produce a diagnostic result; and
an output device configured to at least output the diagnostic result as a graphic diagnostic result,
wherein the graphic self-diagnostic device comprises:
a failure database module configured to at least (i) store a whole picture of the piece of equipment, system, machine or device being diagnosed, at least one installation location diagram and at least one real photo of the one or more parts in advance, and (ii) store information regarding at least one point of failure;
a failure scan module configured to at least scan each of the one or more parts periodically or in response to the self-diagnostic request of the user to at least (i) identify any failed part and store a point of failure for a failed part in the failure database module, and (ii) identify any cleared part whose failure has been cleared and delete a point of failure stored for a cleared part from the failure database module; and
a rendering module configured in response to the self-diagnostic request of the user, to at least (i) invoke the whole picture from the failure database module and mark the failed part in the whole picture based on the stored point of failure for the failed part, and (ii) invoke at least one of an installation location diagram of the failed part and a real photo of the failed part from the failure database module and provide at least one of the installation location diagram of the failed part and the real photo of the failed part as the graphic diagnostic result to the output device.
